(19) United States
(12) Patent Application Publication
(10) Pub. No.: US 2002/0138810 A1
(43) Pub. Date: Sep. 26, 2002

(54) Optical proximity correction (OPC) using automated shape and edge pre-sorting

(76) Inventors: Mark A. Lavin, Katonah, NY (US); Donald J. Samuels, Silverthorne, CO (US); Lars W. Liebmann, Poughquag, NY (US); Henning Haffner, Dresden (DE)

Correspondence Address: Siemens Corporation, Intellectual Property Department, 186 Wood Avenue South, Iselin, NJ, 08830, US

(21) Appl. No.: 09/774,742

(22) Filed: Jan. 31, 2001

(51) Int. Cl. G06F 17/50

(52) U.S. Cl. 716/1

(57) ABSTRACT

There is provided a method for Optical Proximity Correction (OPC) of a semiconductor device. The method includes the step of pre-sorting the shapes and/or the shape edges into groups based on pre-defined criteria. Different regions of interest are applied to at least some of the shapes and the shape edges, based on which of the groups the at least some of the shapes and the shape edges are pre-sorted into. The pre-defined criteria may include: properties or labels associated with the shapes and/or the shape edges during a design process of the semiconductor device; geometric properties of the shapes and/or the shape edges; structural properties of an overall design of the semiconductor device; and the shapes and/or the shape edges for which a larger region of interest is required.

### BACKGROUND

1. Technical Field

The present invention generally relates to semiconductor devices and, in particular, to a method and apparatus for Optical Proximity Correction (OPC) using automated shape and edge pre-sorting. The OPC is performed prior to fabrication of the semiconductor devices.

2. Background Description

Integrated circuit semiconductor devices and packages are fabricated using photolithographic patterning to form complex patterns of various materials that comprise active and passive components and interconnects. Photolithographic patterning starts with a specification of the intended patterns in terms of geometric shapes at specified positions. The specification is embodied in computer data called a physical design or layout. These data are used to generate photomasks, which are similar to photographic negatives, and geometrically equivalent to the patterns in the physical design. By projecting light or other radiation through the photomask, the pattern is transferred to light-sensitive photoresist materials and, after chemical processing, these materials have a stencil-like pattern equivalent to the physical design. Further chemical processes transfer these patterns to the materials that comprise the devices and interconnects.

In practice, each of these steps does not transfer the pattern with perfect fidelity. Thus, the devices and interconnects may differ sufficiently from the intended patterns in the physical design, and consequently may fail to perform as intended. While some of the pattern distortions are random, others depend systematically on the intended pattern and on properties of the fabrication processes. It may be possible to eliminate those systematic distortions by applying to the original physical design compensating counter-distortions, with the intended result that when the compensated patterns are subject to the distortions of photolithographic patterning, the resulting devices and interconnections more closely resemble the original, intended patterns.

This process of compensation is often referred to as Optical Proximity Correction (OPC), since some of the distortions are due to optical characteristics of the systems used to project the photomask patterns onto the photoresist material and, in many cases, the degree of distortion of a particular pattern element depends not only on that element's shape, but also the position and shape of nearby elements. It shall be understood, however, that the term “OPC” as used herein shall refer to compensation for distortions induced by all fabrication processes, not only optical.

In OPC, the automated correction of a designed linewidth is usually based on a calculation that takes into account the original linewidth as well as the placement of neighboring shapes up to a certain distance, called the Region Of Interest (ROI). In general, the larger the distance the program takes into consideration, the more exact the calculated line bias. However, the larger the distance considered by the program, the larger the amount of memory and runtime required by the computer to correct the whole design. The proximity range affecting linewidth error has been demonstrated to be at least 5 um. However, conventional Optical Proximity Correction (OPC) routines used to correct large chips (e.g. 256 Mbit DRAM) are limited to a range of 2 um because of memory and runtime restrictions.

Automated OPC usually applies a fixed ROI for the whole chip or design, irrespective of whether the calculation is performed for a shape or an edge of a shape. Disadvantageously, this means that the ROI for the whole design has to be as large as the maximum distance to a nearest neighbor or the maximum linewidth the required correction needs, even if only one single shape is actually drawn to meet these maximum numbers.

Accordingly, it would be desirable and highly advantageous to have a method and apparatus for performing Optical Proximity Correction (OPC) that allows for a varying region of interest to be applied. Moreover, it would further be desirable and highly advantageous to a have a method and apparatus for performing OPC that allows for different sized regions of interest to be applied to shapes and shape edges based on their size and their proximity to other features.

### SUMMARY OF THE INVENTION

The problems stated above, as well as other related problems of the prior art, are solved by the present invention, a method and apparatus for Optical Proximity Correction (OPC) using automated shape and edge pre-sorting. The OPC is performed prior to fabrication of semiconductor devices.

By pre-sorting the shapes and/or their edges into groups based on various criteria, different Regions Of Interest (ROIs) could be applied for different groups during OPC, depending on the proximity range that could influence the features in the different groups. This approach minimizes computation resources (e.g., memory size, execution time), while using ROIs sufficient to perform OPC to the required accuracy.

According to a first aspect of the invention, there is provided a method for Optical Proximity Correction (OPC) of a semiconductor device. The method includes the step of pre-sorting shapes and/or shape edges into groups based on pre-defined criteria. Different regions of interest are applied to at least some of the shapes and the shape edges, based on which of the groups the at least some of the shapes and the shape edges are pre-sorted into.

According to a second aspect of the invention, the pre-defined criteria include properties associated with the shapes and/or the shape edges during a design process of the semiconductor device.

According to a third aspect of the invention, the pre-defined criteria include labels associated with the shapes and/or the shape edges during the design process of the semiconductor device.

According to a fourth aspect of the invention, the pre-sorting step includes the step of pre-designating at least one particular group for a particular shape and/or a particular shape edge.

According to a fifth aspect of the invention, the pre-defined criteria include geometric properties of the shapes and/or the shape edges.

According to a sixth aspect of the invention, the pre-sorting step includes the step of algorithmically determining at least one of the groups from the geometric properties of the shapes and/or the shape edges.

According to a seventh aspect of the invention, the pre-defined criteria include structural properties of an overall design of the semiconductor device.

According to an eighth aspect of the invention, the pre-sorting step includes the step of algorithmically determining at least one of the groups from the structural properties of the overall design of the semiconductor device.

According to a ninth aspect of the invention, the pre-defined criteria include the shapes and/or the shape edges for which a larger region of interest is required.

According to a tenth aspect of the invention, the pre-defined criteria include a size of the shapes and/or the shape edges.

According to an eleventh aspect of the invention, the pre-defined criteria include a distance of the shapes and/or the shape edges to a next neighbor.

According to a twelfth aspect of the invention, the pre-defined criteria include a minimum line width and/or a maximum line width of the shapes in a single dimension.

According to a thirteenth aspect of the invention, the pre-defined criteria include a minimum distance and/or a maximum distance of the shapes with respect to an adjacent shape.

According to a fourteenth aspect of the invention, the method is implemented by a program storage device readable by machine, tangibly embodying a program of instructions executable by the machine to perform the method steps.

According to a fifteenth aspect of the invention, there is provided a method for Optical Proximity Correction (OPC) of a semiconductor device. The method includes the step of pre-sorting shapes and/or shape edges into groups based on pre-defined criteria. A smallest region of interest corresponding to each of the groups is respectively identified. The identified smallest region of interest corresponding to each of the groups is respectively applied to the shapes and/or the shape edges included therein.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system to which the present invention may be applied according to an illustrative embodiment thereof;

FIG. 2 is a diagram illustrating a design level of a semiconductor device to which Optical Proximity Correction (OPC) is to be applied, according to an illustrative embodiment of the invention; and

FIG. 3 is a flow diagram illustrating a method for Optical Proximity Correction (OPC) of a semiconductor device, according to an illustrative embodiment of the invention.

### DETAILED DESCRIPTION OF PREFERRED EMBODIMENTS

The present invention is directed to a method and apparatus for Optical Proximity Correction (OPC) using automated shape and edge pre-sorting. The OPC is performed prior to fabrication of semiconductor devices.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

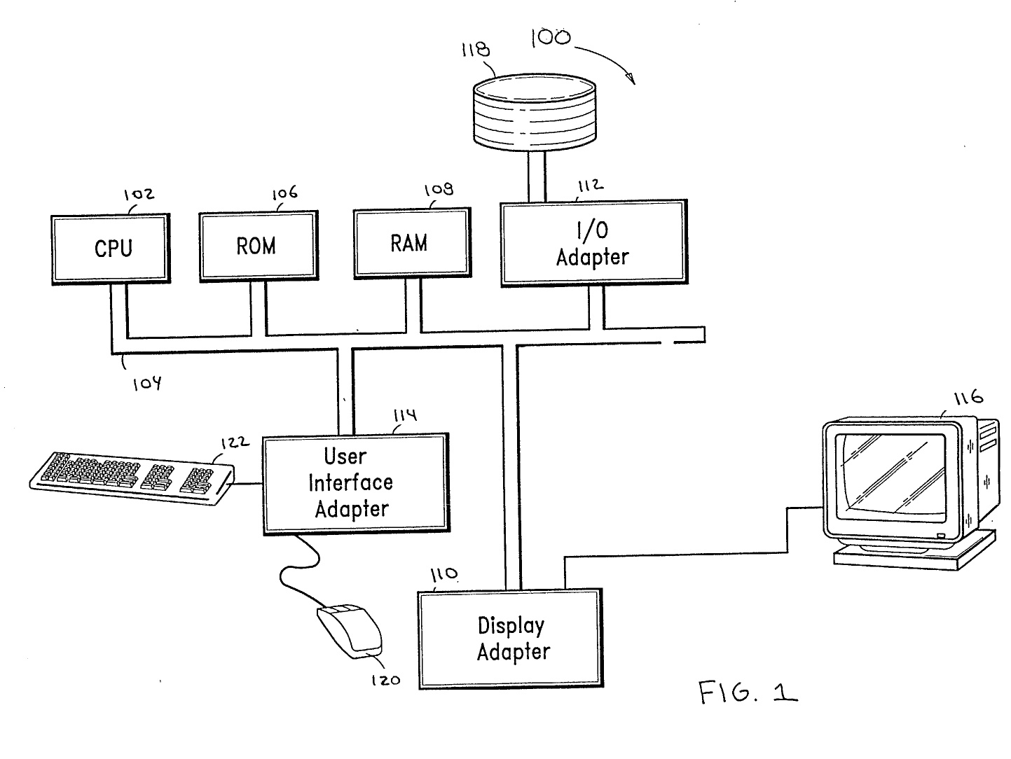

FIG. 1 is a block diagram of a computer processing system 100 to which the present invention may be applied according to an illustrative embodiment thereof. The computer processing system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to the system bus 104 by the display adapter 110. A disk storage device (e.g., a magnetic or optical disk storage device) 118 is operatively coupled to the system bus 104 by the I/O adapter 112.

A mouse 120 and keyboard 122 are operatively coupled to the system bus 104 by the user interface adapter 114. The mouse 120 and keyboard 122 may be used to input/output information to/from the computer processing system 100.

A brief description of the present invention with respect to the computer processing system 100 (or alternative means) will now be given in accordance with an illustrative embodiment of the invention. Computer data representing the physical design are read into memory, and those shapes and related data structures pertinent to one of the photomasks to be used for lithographic patterning are isolated. Next, the shapes and/or edges comprising those shapes are sorted into different groups according to one or more criteria. The criteria that could be used to designate particular groups include, but are not limited to:

(i) The intended group for certain shapes and/or shape edges may be designated explicitly as part of the design process, through properties or labels associated with those shapes and/or shape edges.

(ii) The intended group may be determined algorithmically from the geometric properties of the shapes and/or the shape edges, e.g., their minimum width.

(iii) The intended group may be determined algorithmically based on structural properties of the overall design, e.g., shapes arranged in arrays with small pitch.

(iv) The intended group may be determined as a side-effect of the OPC algorithm: The algorithm may use a small starting ROI, and identify those shapes for which a larger ROI is required.

Given the teachings of the invention provided herein, one of ordinary skill in the related art will contemplate these and various other criteria for sorting shapes and or shape edges while maintaining the spirit and scope of the invention.

The sorting process not only divides the shapes and/or shape edges into groups but also identifies the smallest ROI appropriate for each group. Next, the OPC algorithm is applied to the shapes and/or edges of each group, using the specified ROI for the group. Finally, the data representing the result of OPC, the compensated shapes, are written out from memory for transfer to the fabrication processes.

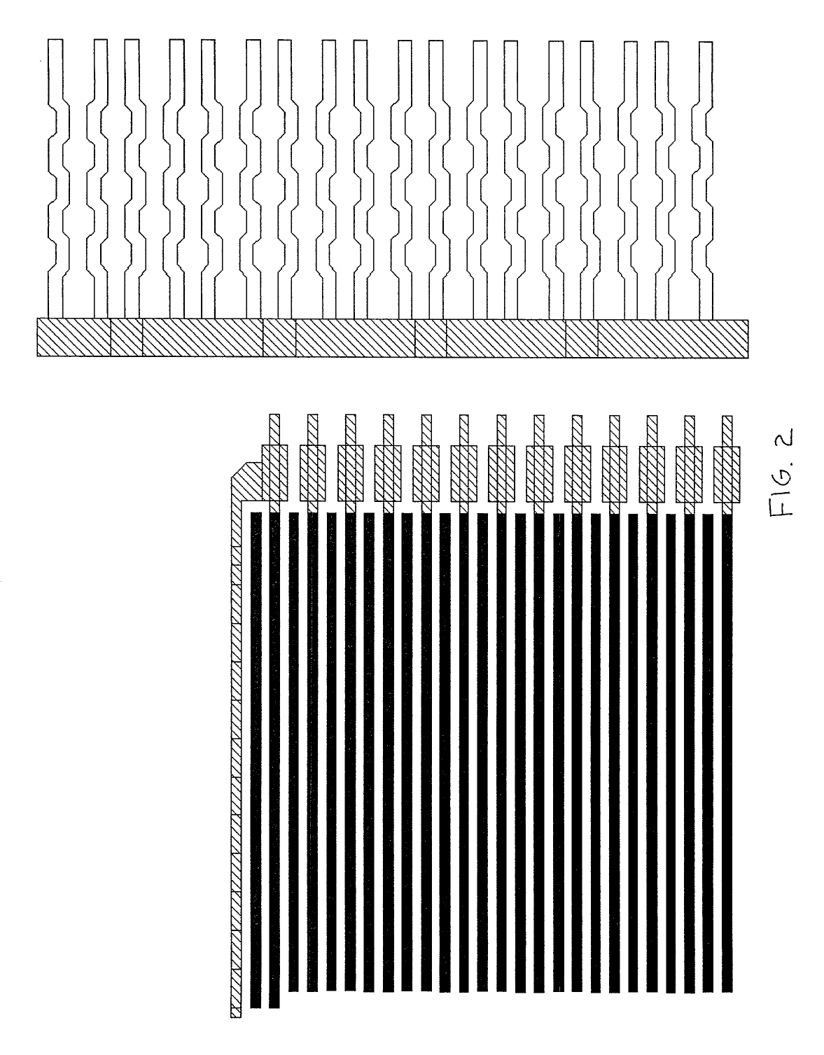

FIG. 2 is a diagram illustrating a design level of a semiconductor device to which Optical Proximity Correction is to be applied, according to an illustrative embodiment of the invention. Three groups were defined in the illustrative embodiment of FIG. 2. The first group is designated by solid black. The second group is designated by a crosshatch pattern. The third group is designated by a black outline. The shapes in the first group are designed such that at least one dimension is as small as 0.250 um and the maximum distance to a nearest neighbor is not larger than 0.250 um. For the shapes in the third group, the preceding numbers are both 0.600 um. The shapes in the second group contain all the remaining shapes.

With respect to FIG. 2, a full level OPC is performed which takes the linewidth and the distance to the nearest neighbor into consideration for calculating the required edge movement. The OPC can be set up such that a different ROI is applied to each group of shapes (0.250 um for the shapes in the first group, 0.600 um for the shapes in the third group and a possibly much larger figure than 2.0 um for the shapes in the second group). This now becomes possible in terms of memory usage and correction runtime since the number of shapes in the second group is very little compared to the total number of shapes in a state-of-the-art DRAM design level with a minimum critical dimension of 0.175 um.

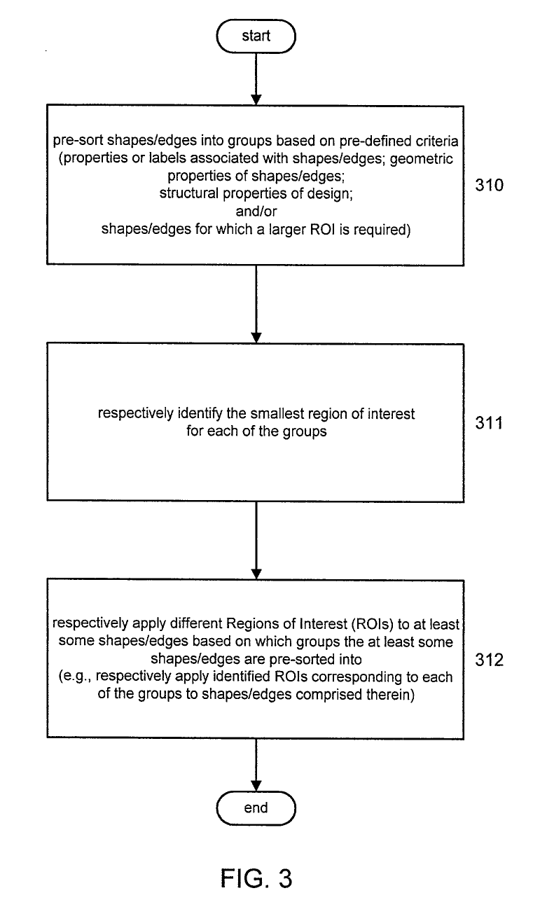

FIG. 3 is a flow diagram illustrating a method for Optical Proximity Correction (OPC) of a semiconductor device, according to an illustrative embodiment of the invention.

Shapes and/or shape edges of the semiconductor device are pre-sorted into groups based on pre-defined criteria (step 310). The pre-defined criteria may include, for example: properties or labels associated with shapes and/or shape edges during the design process of the semiconductor device; geometric properties of the shapes and/or the shape edges; structural properties of the overall design of the semiconductor device; and the shapes and/or the shape edges for which a larger ROI is required.

Examples of structural properties of the shapes and/or shape edges include, for example, the size of the shapes and/or the shape edges, and the minimum width of the shapes and/or the shape edges. Examples of structural properties of the overall design include, for example: shapes arranged in arrays with small pitch; the distance of the shapes and/or the shape edges to a next neighbor; a minimum line width and/or a maximum line width of the shapes in a single dimension; and a minimum distance and/or a maximum distance of the shapes and/or the shape edges with respect to an adjacent shape(s) and/or edge(s). The preceding criteria for sorting are merely illustrative and, thus, the invention is not limited to only the preceding criteria or any other criteria described herein. Given the teachings of the invention provided herein, one of ordinary skill in the related art will contemplate these and various other criteria for sorting shapes and/or shape edges while maintaining the spirit and scope of the invention.

The smallest region of interest for each of the groups is respectively identified (step 311).

The identified region of interest corresponding to each of the groups is respectively applied to the shapes and/or the shape edges included therein (step 312).

As noted above, the invention minimizes computation resources (e.g., memory size, execution time), while applying ROIs sufficient to perform OPC to the required accuracy. These and other features and advantages of the invention are readily apparent to one of ordinary skill in the related art.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method for Optical Proximity Correction (OPC) of a semiconductor device, comprising the steps of:
pre-sorting at least one of shapes and shape edges into groups based on pre-defined criteria; and
applying different regions of interest to at least some of the shapes and the shape edges, based on which of the groups the at least some of the shapes and the shape edges are pre-sorted into.

2. The method according to claim 1, wherein the pre-defined criteria comprise properties associated with at least one of the shapes and the shape edges during a design process of the semiconductor device.

3. The method according to claim 1, wherein the pre-defined criteria comprise labels associated with at least one of the shapes and the shape edges during the design process of the semiconductor device.

4. The method according to claim 1, wherein said pre-sorting step comprises the step of pre-designating at least one particular group for at least one of a particular shape and a particular shape edge.

5. The method according to claim 1, wherein the pre-defined criteria comprise geometric properties of at least one of the shapes and the shape edges.

6. The method according to claim 4, wherein said pre-sorting step comprises the step of algorithmically determining at least one of the groups from the geometric properties of the at least one of the shapes and the shape edges.

7. The method according to claim 1, wherein the pre-defined criteria comprises structural properties of an overall design of the semiconductor device.

8. The method according to claim 7, wherein said pre-sorting step comprises the step of algorithmically determining at least one of the groups from the structural properties of the overall design of the semiconductor device.

9. The method according to claim 1, wherein the pre-defined criteria comprise at least one of the shapes and the shape edges for which a larger region of interest is required.

10. The method according to claim 1, wherein the pre-defined criteria comprise a size of at least one of the shapes and the shape edges.

11. The method according to claim 1, wherein the pre-defined criteria comprise a distance of at least one of the shapes and the shape edges to a next neighbor.

12. The method according to claim 1, wherein the pre-defined criteria comprises at least one of a minimum line width and a maximum line width of the shapes in a single dimension.

13. The method according to claim 1, wherein the pre-defined criteria comprises at least one of a minimum distance and a maximum distance of the shapes with respect to an adjacent shape.

14. The method according to claim 1, wherein said method is implemented by a program storage device readable by machine, tangibly embodying a program of instructions executable by the machine to perform said method steps.

15. A method for Optical Proximity Correction (OPC) of a semiconductor device, comprising the steps of:
pre-sorting at least one of shapes and shape edges into groups based on pre-defined criteria;
respectively identifying a smallest region of interest corresponding to each of the groups; and
respectively applying the identified smallest region of interest corresponding to each of the groups to at least one of the shapes and the shape edges comprised therein.

16. The method according to claim 15, wherein the pre-defined criteria comprise properties associated with at least one of the shapes and the shape edges during a design process of the semiconductor device.

17. The method according to claim 15, wherein the pre-defined criteria comprise labels associated with at least one of the shapes and the shape edges during the design process of the semiconductor device.

18. The method according to claim 15, wherein said pre-sorting step comprises the step of pre-designating at least one particular group for at least one of a particular shape and a particular shape edge.

19. The method according to claim 15, wherein the pre-defined criteria comprise geometric properties of at least one of the shapes and the shape edges.

20. The method according to claim 19, wherein said pre-sorting step comprises the step of algorithmically determining at least one of the groups from the geometric properties of the at least one of the shapes and the shape edges.

21. The method according to claim 15, wherein the pre-defined criteria comprises structural properties of an overall design of the semiconductor device.

22. The method according to claim 21, wherein said pre-sorting step comprises the step of algorithmically determining at least one of the groups from the structural properties of the overall design of the semiconductor device.

23. The method according to claim 15, wherein the pre-defined criteria comprise at least one of the shapes and the shape edges for which a larger region of interest is required.

24. The method according to claim 1, wherein said method is implemented by a program storage device readable by machine, tangibly embodying a program of instructions executable by the machine to perform said method steps.
